(19) United States
(12) Patent Application Publication
(10) Pub. No.: US 2018/0345060 A1
(43) Pub. Date: Dec. 6, 2018

(54) Fire suppression for an electric transformer box

(71) Applicant: GelTech Solutions, Inc., Jupiter, FL (US)

(72) Inventor: Peter Cordani, Palm Beach Gardens, FL (US)

(21) Appl. No.: 15/995,833

(22) Filed: Jun. 1, 2018

Related U.S. Application Data
(60) Provisional application No. 62/514,456, filed on Jun. 2, 2017.

(51) Int. Cl. A62C 35/02

(52) U.S. Cl. CPC A62C 35/026

(57) ABSTRACT

A device for suppressing or extinguishing electrical fires in an electrical box, in particular an open top electrical box isolating a transformer. The device is based upon a bulk package receptacle placed within the electrical box having a liner filled with a fire suppressant material capable of suffocating or eliminating a fire. Should a fire occur the bulk package receptacle bursts at the point of combustion and the fire suppression properties of the fire suppressant would immediately be dispensed over the electrical material and extinguish any associated fire. In the preferred embodiment the bag consumes about 90% of the airspace and contained sufficient fluid volume to contain within the container. The admixture further encapsulates noxious and toxic gases associated with electrical fires.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 62/514,456, entitled “FIRE SUPPRESSION FOR AN ELECTRIC TRANSFORMER BOX”, filed Jun. 2, 2017. The contents of which the above referenced application is incorporated herein by reference.

### FIELD OF THE INVENTION

This invention relates to the field of fire prevention, and more particularly to a device for placement within a transformer box for dispersion of a fire suppressant should a fire within the electrical box occur.

### BACKGROUND OF THE INVENTION

In many cities, the utilities are located beneath the surface of the earth, usually beneath the surface of the streets. These utilities are placed in tunnels or conduits. In older cities, such as New York City, these utilities have been located in these conduits for many years/decades. Over time, the conduits which carry these utilities wear out and break. The failure of electrical transmission lines in these conduits and tunnels is a serious problem. These failures usually result in fires, which must be quickly extinguished to prevent further damage.

While it is desirable to replace very old utilities in conduits and tunnels, it is not always practical. Due to financial restraints and other limitations, most of these electrical transmission lines have not been replaced, yet higher electrical demands are placed on the system. Unfortunately, failure of older electrical transmission lines can result in an electrical fire. These fires are commonly discovered when smoke is seen rising from manhole covers in the streets and sidewalks. It has been estimated by Consolidated Edison that there are approximately 40 electrical fires per day under the streets of New York City.

The cost of repairing and replacing the electrical transmission lines damaged by these fires is approximately $100,000.00 per linear foot of transmission line. Therefore, it is imperative that these fires be extinguished as quickly as possible. Inspection of electrical lines can help pinpoint potential trouble areas. Unfortunately, even an inspection of the lines can trigger a fire. For instance, the opening of a manhole cover can provide the oxygen needed to support a fire. Similarly, a lineman performing an inspection may disturb a conduit, resulting in arcing of electric lines, possibly triggering a fire.

Ground positioned transformers are also of great concern. Transformers are electrical devices that use electromagnetic induction to increase or decrease the alternating voltages for electrical power applications. The basic transformer technology was developed in the late 1800's and has changed very little to date, as the operation remains based upon Faraday's law. Unfortunately, transformers are known to fail without notice and can result in fires. Unforeseen events, such as lighting strikes, voltage surges, degradation of the insulation, component damage, manufacturing defects, or even intentional sabotage can result in an uncontrolled fire. Smaller transformers are found in a containment box placed on an electrical pole, or in an enclosed containment box positioned above ground. Larger transformers may be placed in an open containment box comprising a floor with four walls. The transformers may include a large quantity of cooling oil, making any fire problematic. The larger transformers are typically placed within a cement containment box consisting of a floor with four walls. In most instances, the containment box has an open top. Should a fire occur, the goal is to keep the fire within the containment box. However, depending on the circumstances, the containment box may be insufficient in preventing a catastrophic fire.

U.S. Pat. No. 6,834,728 discloses a system for extinguishing a fire in a tunnel. The system includes a conduit for delivering a fire extinguishing liquid, and a trough extending parallel to the conduit for receiving liquid from the conduit. A carriage is arranged to move on a track which includes an upper edge of the trough. The carriage carries a pump having a nozzle, a video camera, and an inlet; each of which can be controlled robotically from a remote control station. The inlet is deployed in the trough to draw liquid from the trough.

U.S. Pat. No. 7,096,965 discloses a method of proportioning a foam concentrate into a non-flammable liquid to form a foam concentrate/liquid mixture and create a flowing stream of the foam concentrate/liquid mixture. The apparatus of this invention is adapted for expanding and dispensing foam, and includes a housing defining an interior through which extends a discharge line. The ends of the housing are closed about the ends of the discharge line, and the ends of the discharge line extend beyond the ends of the housing to define a connector at one end for receiving a stream of foam concentrate/liquid and at the opposite end to define the foam dispensing end of the apparatus.

U.S. Pat. No. 7,104,336 discloses a method and apparatus for proportioning a foam concentrate into a non-flammable liquid to form a foam concentrate/liquid mixture and create a flowing stream of the foam concentrate/liquid mixture similar to the method and apparatus of U.S. Pat. No. 7,096,965.

U.S. Pat. No. 7,124,834 discloses a method for extinguishing a fire in a space such as a tunnel. The method includes spraying a fire extinguishing medium into the space using spray heads. In a first stage of the method, the flow and temperature of the hot gases produced by the fire are influenced by spraying an extinguishing medium into the space, especially by creating in the space at least one curtain of extinguishing medium. At least some spray heads in the space are pre-activated into a state of readiness. In a second stage of the method, at least one spraying head is activated to produce a spray of extinguishing medium.

U.S. patent application Ser. No. 11/680,803 is entitled “Process for Fire Prevention and Extinguishing”, the contents of which are incorporated herein by reference. In this application, a process for retarding or extinguishing conflagrations using a superabsorbent polymer in water is disclosed. The reaction of the water with the polymer creates a gel-like substance with a viscosity that allows the mixture to be readily pumped through a standardized 2.5 gallon water based fire extinguisher, yet viscous enough to cover vertical and horizontal surfaces to act as a barrier to prevent fire from damaging such structures, minimizing the manpower needed to continuously soak these structures.

U.S. Pat. No. 5,989,446 discloses a water additive for use in fire extinguishing and prevention. The additive comprises a cross-linked water-swellable polymer in a water/oil emulsion. The polymer particles are dispersed in an oil emulsion wherein the polymer particles are contained within discrete water “droplets” within the oil. With the help of an emulsifier, the water “droplets” are dispersed relatively evenly throughout the water/oil emulsion. This allows the additive to be introduced to the water supply in a liquid form, such that it can be easily educted with standard firefighting equipment.

U.S. Pat. No. 5,190,110 discloses the fighting of fires or protection of objects from fire by applying water which comprises dispersing in the water particles of a cross-linked, water-insoluble, but highly water-swellable, acrylic acid derivative polymer in an amount insufficient to bring the viscosity above 100 mPa's. Advantageously, the particles are present in an amount such that, after swelling, the swollen particles hold 60% to 70% by weight of the total water; the polymer being a copolymer of an acrylic acid, the water containing silicic acid and/or a silicate, as well as sodium, potassium or ammonium ions. The water is freely pumpable, but the swollen particles adhere to surfaces they contact rather than running off rapidly.

U.S. Pat. No. 5,849,210 discloses a method of preventing or retarding a combustible object from burning, including the steps of mixing water with a super absorbent polymer (“SAP”) to form one at least partially hydrated SAP, and applying the at least partially hydrated SAP to the combustible object, before or after combustion. In another embodiment, an article of manufacture includes a SAP that is prehydrated and is useful for preventing a combustible object from burning, or preventing penetration of extreme heat or fire to a firefighter or other animal.

U.S. Pat. No. 5,087,513 discloses polybenzimidazole polymer/superabsorbent polymer particles. These particles are prepared by either mixing the superabsorbent polymer particulates with the polybenzimidazole polymer solution during the formation of the polybenzimidazole article, or forming a composite of a polybenzimidazole film or fiber material layer with a superabsorbent polymer particulate containing layer. These polybenzimidazole products absorb large amounts of fluid while retaining the flame retardancy and chemical unreactivity of conventional polybenzimidazole materials.

U.S. Pat. No. 4,978,460 discloses a particulate additive for water for firefighting containing a strongly swelling water-insoluble high molecular weight polymer as a gelatinizing agent, which comprises a water-soluble release agent which causes the particles of said gelatinizing agent not to swell, the particles of the gelatinizing agent being encased or dispersed in the release agent. Suitable release agents include polyethylene glycol, sugars, mannitol, etc. The gelatinizing agent may be a moderately cross-linked water-insoluble acrylic or methacrylic acid copolymer.

U.S. Pat. No. 5,519,088 discloses an aqueous gel comprising a polymer of (meth)acrylamide or particular (meth)acrylamide derivative(s), particulate metal oxide(s) and an aqueous medium, a process for producing said gel, and products utilizing said gel. This aqueous gel can be produced so as to have transparency, be highly elastic and fire resistant, and can prevent the spreading of flames. The aqueous gel, when produced transparent, becomes cloudy when heated or cooled and is useful for the shielding of heat rays or cold radiation.

What is needed in the art is a method of suppressing fires and a device that can be placed within a transformer box to provide fire suppression.

### SUMMARY OF THE INVENTION

The instant invention comprises a method and device for suppressing or extinguishing electrical fires in a transformer or electrical box. The device is based upon a bulk package receptacle placed within the electrical box which has a liner filled with a fire suppressant material capable of suffocating or eliminating a fire. Should a fire occur, the bulk package receptacle bursts at the point of combustion, and the fire suppression and extinguishing properties of the fire suppressant would immediately extinguish any associated fire. The fire suppressant or compositions thereof provide an insulating ability to inhibit arcing, suppressing the fires until a lineman can turn off the power and repair the problem. In the preferred embodiment, the bag consumes about 90% of the airspace within the container.

Accordingly, it is an objective of the present invention to provide a receptacle for placement of fire suppressant, or compositions thereof, within an open transformer box or electrical box.

It is a further objective of the present invention to provide a receptacle that can accommodate most any size box and includes an adjustable height.

It is a further objective of the present invention to provide a receptacle that can be placed within an electrical box and will conform to the shape of the box, including any extruding conduit, wires or other obstacles.

Still another objective of the present invention is to provide a receptacle that is easily removable by relocation of the fire suppressant material permitting ease of container repositioning.

It is still yet another objective of the present invention to provide a bulk receptacle that will work with any fire suppressant or fire suppressant compositions.

Still another objective of the present invention is to provide a bulk receptacle that includes means for notification of discharge by either detecting the loss of a positive pressure, or the detection of heat.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial view of an electrical containment box;

FIG. 2 is a perspective view of the receptacle;

FIG. 3 is a perspective view of the inner liner;

FIG. 4 is an exploded view of the access port; and

FIG. 5 is a pictorial view of the liner and receptacle positioned within the electrical containment box.

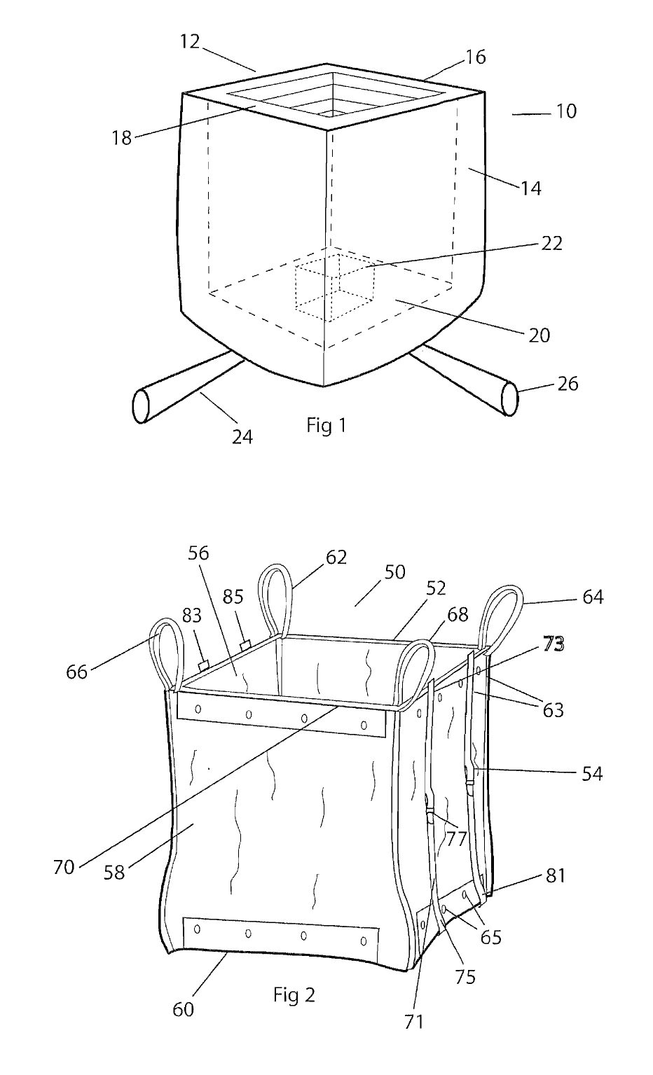

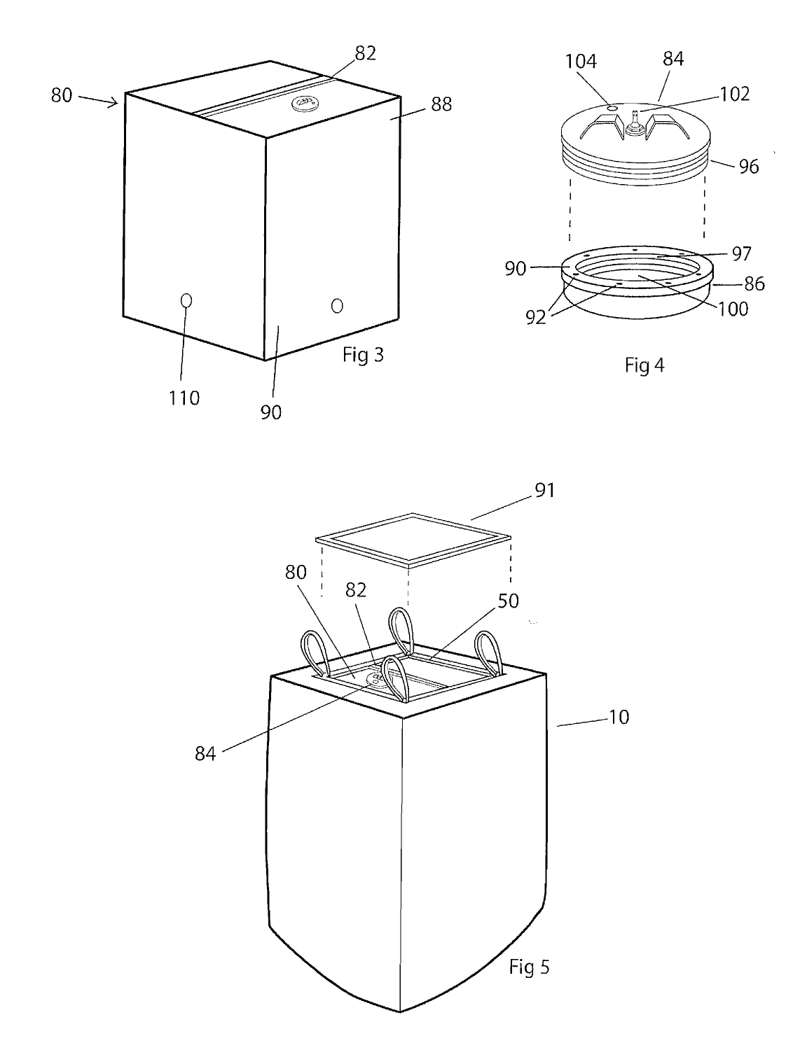

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Referring to the Figures, illustrated is an open electrical containment box (10) consisting of a front wall (12), a rear wall (14), side walls (16, 18), and a bottom wall (20). Electrical components, such as a transformer (22) or other switch like mechanism is located along the bottom wall (20) with electrical inlets (24) and outlets (26) for bringing power into and out of the transformer (22). The receptacle (50) is a woven polyester bulk container having a mil thickness of about six mils. The preferred size holds a capacity of about 750 gallons with an objective of consuming about 90% of the airspace within the containment box (10). The receptacle (50) is formed from side walls (52, 58), end walls (54, 56) and a bottom wall (60). Lifting loops (62, 64, 66 & 68) are located at each corner and provide reinforcement of the corners that extend from an upper edge (70) to the bottom wall (60). Upper tie down grommets (63) are positioned around the upper edge (70), and lower tie down grommets (65) are positioned around a lower edge adjacent the bottom wall (60). The grommets can be used with tie down straps, not shown, to maintain the receptacle in position should an electrical short result in an explosive reaction. The bag includes at least one strap (71) having a first end (73) secured to the upper edge (70) of the bag and a second end (75) secured to a lower edge (60) of bag with a buckle (77) attached to said strap (71) for adjusting the distance between the upper edge (70) and lower edge (75). In the preferred embodiment, two straps (71) and (81) are located on one side of the bag and two straps (83, 85) are located on the opposite side. The straps are used to adjust the height of the bag when placed with a containment box (10). The straps are used to limit the height of liner (80) allowing the use in most any height containment box (10). A cover panel (91) can be placed over the liner (80) and cinched in position by the straps. The cover panel (91) conceals the upper surface of the liner from debris, such as discarded cigarettes, from compromising the integrity of the liner (80). Preferably the cover panel (91) is made of plastic having a thickness sufficient to prevent warping when the liner is being accessed. In the preferred embodiment the upper surface of the liner (80) is positioned about six inches beneath the upper edge of the container (10).

An inner liner (80) is sized for placement within the receptacle (50), the inner liner having sewn and sealed seams (82) to allow pressurization of the liner (80) up to about 15 psi. The liner (80) can be constructed from a flexible material capable of providing an airtight environment. Flexible material such as latex, natural latex rubber, low density polypropylene, polyethylene, polyurethane, polyisoprene or other synthetic materials are suitable. In the preferred embodiment, the container (50) and inner liner (80) have a melting temperature of about 350 degrees Fahrenheit which may result in a breach. When subjected to a temperature at or above the melting temperature, the admixture within the inner liner will be expelled in the event of a breach, thus extinguishing the cause of the breach. The inner liner (80) includes an access lid (84) that is threadingly attached to the inner liner (80) by use of a support element (86) that is placed on an inner surface of the side wall (88) with a retainer ring (90) placed on an outer surface of the side wall (88) and secured thereto by fasteners (92). The access lid (84) includes threads (96) for securing to reciprocal threads (97) on the inner surface of the retainer ring to provide an airtight seal of the fill port aperture or access port (100). The fill port (100) is constructed and arranged for attachment of an air supply with an air valve assembly on access port. In the preferred embodiment, an RF pressure sensor (104) is placed in the access lid (84) to determine if the bag is maintaining a positive pressure. Should a loss of positive pressure occur, the sensor will detect the pressure drop and provide either a local alarm or be coupled to a transmitter to provide a remote alarm. Low pressure is an indication that the inner liner (80) has been breached. For instance, should a transformer burst, the inner liner will accept the burst for the protection of the immediate persons and property. The burst will likely be caused by an arching, wherein the temperature is sufficient to breach the liner, and release the admixture. In addition, or alternatively, temperature sensors (110) can be placed around the inner liner using either RF or local wire to detect temperature elevations, which also indicate the occurrence of a fire.

The inner liner (80) may also be formed from useful elastomers including diene-rubbers, such as styrene-butadiene rubber (SBR), cis-butadiene rubber (BR), natural rubber (NR); polyolefin plastomers, such as ethylene-butene, ethylene-hexene, and ethylene-octene plastomers; polyolefin elastomers, such as propylene-ethylene, propylene-hexene, ethylene-octene elastomers; and thermoplastic elastomers (TPE), such as hydrogenated styrene-butadiene (or isoprene) block copolymers, polyester, and polyamide TPE; and combinations of two or more of the foregoing. In some embodiments, the flexible material can include fibers which may further impart strength or flexibility. In some embodiments, the inner liner (80) may employ a thinner wall or have material sections having a lower melting temperature as compared to the rest of the liner such that, if the liner melts or perforates when subjected to heat, the fire suppressant or compositions thereof will extrude into the conduit and extinguishing the fire.

In the preferred embodiments, the fire suppressant placed within the inner liner (80) through the access port (100) is a super absorbent aqueous based and biodegradable polymer marketed under the tradename FIREICE®. The fire suppressant is in an amount sufficient to extinguish an electrical fire and suppress the spread of the electrical fire. Examples of preferred polymers are: cross-linked modified polyacrylamides/potassium acrylate and polyacrylamides/sodium acrylate. Other suitable polymers include, albeit are not limited to, carboxy-methylcellulose, alginic acid, cross-linked starches, and cross-linked polyamino acids.

The admixture further operates to cool electrical components using heat transfer from the ground. As the ground maintains a cooler core temperature, the lower half of the admixture within the liner (80) remains less than 55 degrees as the admixture works as a dissipating heat sink for the electrical components. Electrical fires present a unique problem pertaining to how these fires should be extinguished and suppressed. Water is normally used to fight fires because it can quickly cool down the burning material, there is usually a large supply of it ready for use, and it is relatively inexpensive. However, water and electricity are harmful, if not deadly, to individuals when brought into contact with each other. Normally, when water hits an active electrical circuit or electrical component, it shorts out the circuit or component, which usually results in destruction of the circuit or component. Further, when individuals are in close proximity to the water contacting the electricity, there is a strong likelihood that the water will act as a conductor and carry electricity to the individuals, resulting in serious injury or death of the individuals. Since water spreads rapidly in all directions on surfaces, electricity which comes in contact with the water will be conducted to wherever the water flows. Because it is difficult to prevent water from flowing to certain areas, there is a strong likelihood that individuals will be injured or killed when they come in contact with this water.

As used herein, a “fire suppressant” composition is meant to be inclusive of all components of the composition. Conventional fire suppressants may also be substituted with varies degrees of effectiveness. Fire suppressant compositions include: penta-bromodiphenyl ether, octa-bromodiphenyl ether, deca-bromodiphenyl ether, short-chain chlorinated paraffins (SCCPs), medium-chain chlorinated paraffins (MCCPs), hexabromocyclododecane (HBCD), tetrabromobisphenol A (TBBPA), tetrabromobisphenol A ether, pentabromotoluene, 2,3-dibromopropyl-2,4,6-tribromophenyl ether, tetrabromobisphenol A, bis(2,3-dibromopropyl ether), tris(tribromophenoxy)triazine, tris(2-chloroethyl)phosphate (TCEP), tris(2-chloro-1-methylethyl)phosphate (TCPP or TMCP), tris (1,2-dichloropropyl)phosphate (TDCP), 2,2-bis(chloromethyl)-trimethylenebis(bis(2-chloroethyl)phosphate), melamine cyanurate, antimony trioxide S_{b2O3} (ATO), boric acid, ammonium polyphosphate (APP), aluminum ammonium polyphosphate, aluminum hydroxide, magnesium hydroxide red phosphorous, 1,2-bis(tribromophenoxy)ethane, 2,4,6-tribromophenyl glycidyl ether, tetrabromophthalic anhydride, 1,2-bis(tetrabromophthalimide) ethane, tetrabromo dimethyl phthalate, tetrabromo disodium phthalate, decabromodiphenyl ether, tetradecabromodi(phenoxyl)benzene, 1,2-bis(pentabromophenyl)ethane, bromo-trimethyl-phenyl-hydroindene, pentabromobenzyl acrylate, pentabromobenzyl bromide, hexabromobenzene, pentabromotoluene, 2,4,6-tribromophenyl maleimide, hexabromocyclododecane, N,N′-1,2-bis(dibromonorbornyldicarbimide) ethane, pentabromochloro-cyclohexane, tri(2,3-dibromopropyl)isocyanurate, bromo-styrene copolymer, tetrabromobisphenol A-carbonate oligomer, polypentabromobenzyl acrylate, polydibromophenylene ether; chlorinated flame retardants such as dechlorane plus, HET anhydride (chlorendic anhydride), perchloropentacyclodecane, tetrachlorobisphenol A, tetrachlorophthalic anhydride, hexachlorobenzene, chlorinated polypropylene, chlorinated polyvinyl chloride, vinyl chloride-vinylidene chloride copolymer, chlorinated polyether, hexachloroethane; organic phosphorus flame retardants such as 1-oxo-4-hydroxymethyl-2,6,7-trioxa-1-phosphabicyclo [2,2,2] octane, 2,2-dimethyl-1,3-propanediol-di (neopentylglycol)diphosphate, 9,10-dihydro-9-oxa-10-phosphaphenanthrene-10 oxide, bis(4-carboxyphenyl) phenyl phosphine oxide, bis(4-hydroxyphenyl)-phenyl phosphine oxide, phenyl(diphenylsulfone) phosphate oligomer; phosphorus-halogenated flame retardants such as tris(2,2-di(bromomethyl)-3-bromopropyl)phosphate, tris(dibromophenyl)phosphate, 3,9-bis(tribromophenoxy)-2,4,8,10-tetraoxa-3,9-diphosphaspiro[5,5]-3,9-dioxo-undecane, 3,9-bis(pentabromophenoxy)-2,4,8,10-tetraoxa-3,9-diphosphaspiro[5,5]-3,9-dioxo-undecane, 1-oxo-4-tribromophenoxycarbonyl-2,6,7-trioxa-1-phosphabicyclo[2,2,2]octane, p-phenylene-tetrakis(2,4,6-tribromophenyl)-diphosphate, 2,2-di(chloromethyl)-1,3-propanediol-di(neopentyl glycol)diphosphate, 2,9-di(tribromo-neopentyloxy)-2,4,8,10-tetraoxa-3,9-diphosphaspiro[5,5]-3,9-dioxo-undecane; nitrogen-based flame retardants or phosphorus-nitrogen-based flame retardants such as melamine, melamine cyanurate, melamine orthophosphate, dimelamine orthophosphate, melamine polyphosphate, melamine borate, melamine octamolybdate, cyanuricacid, tris(hydroxyethyl)isocyanurate, 2,4-diamino-6-(3,3,3-trichloro-propyl)-1,3,5-triazine, 2,4-di(N-hydroxymethyl-amino)-6-(3,3,3-trichloro-propyl-1,3,5-triazine), diguanidinehydrophosphate, guanidine dihydrogen phosphate, guanidine carbonate, guanidine sulfamate, urea, urea dihydrogen phosphate, dicyandiamide, melamine bis(2,6,7-trioxa-phospha-bicyclo[2.2.2]octane-1-oxo-4-methyl)-hydroxy-phosphate, 3,9-dihydroxy-3,9-dioxo-2,4,8,10-tetraoxa-3,9-diphosphaspiro[5.5]undecane-3,9-dimelamine, 1,2-di(2-oxo-5,5-dimethyl-1,3-dioxa-2-phosphacyclohexyl-2-amino) ethane, N,N′-bis(2-oxo-5,5-dimethyl-1,3-dioxa-2-phosphacyclohexyl)-2,2′-m-phenylenediamine, tri(2-oxo-5,5-dimethyl-1,3-dioxa-2-phosphacyclohexyl-2-methyl)amine, hexachlorocyclotriphosphazene; and inorganic flame retardants such as red phosphorus, ammonium polyphosphate, diammonium hydrophosphate, ammonium dihydrogen phosphate, zinc phosphate, aluminum phosphate, boron phosphate, antimony trioxide, aluminum hydroxide, magnesium hydroxide, hydromagnesite, alkaline aluminum oxalate, zinc borate, barium metaborate, zinc oxide, zinc sulfide, zinc sulfate heptahydrate, aluminum borate whisker, ammonium octamolybdate, ammonium heptamolybdate, zinc stannate, stannous oxide, stannic oxide, ferrocenc, ferric acetone, ferric oxide, ferro-ferric oxide, ammonium bromide, sodium tungstate, potassium hexafluorotitanate, potassium hexafluorozirconate, titanium dioxide, calcium carbonate, barium sulfate, sodium bicarbonate, potassium bicarbonate, cobalt carbonate, zinc carbonate, basic zinc carbonate, heavy magnesium carbonate, basic magnesium carbonate, manganese carbonate, ferrous carbonate, strontium carbonate, sodium potassium carbonate hexahydrate, magnesium carbonate, calcium carbonate, dolomite, basic copper carbonate, zirconium carbonate, beryllium carbonate, sodium sesquicarbonate, cerium carbonate, lanthanum carbonate, guanidine carbonate, lithium carbonate, scandium carbonate, vanadium carbonate, chromium carbonate, nickel carbonate, yttrium carbonate, silver carbonate, praseodymium carbonate, neodymium carbonate, samarium carbonate, europium carbonate, gadolinium carbonate, terbium carbonate, dysprosium carbonate, holmium carbonate, erbium carbonate, thulium carbonate, ytterbium carbonate, lutetium carbonate, aluminum diacetate, calcium acetate, sodium bitartrate, sodium acetate, potassium acetate, zinc acetate, strontium acetate, nickel acetate, copper acetate, sodium oxalate, potassium oxalate, ammonium oxalate, nickel oxalate, manganese oxalate dihydrate, iron nitride, sodium nitrate, magnesium nitrate, potassium nitrate, zirconium nitrate, calcium dihydrogen phosphate, sodium dihydrogen phosphate, sodium dihydrogen phosphate dihydrate, potassium dihydrogen phosphate, aluminum dihydrogen phosphate, ammonium dihydrogen phosphate, zinc dihydrogen phosphate, manganese dihydrogen phosphate, magnesium dihydrogen phosphate, disodium hydrogen phosphate, diammonium hydrogen phosphate, calcium hydrogen phosphate, magnesium hydrogen phosphate, ammonium phosphate, magnesium ammonium phosphate, ammonium polyphosphate, potassium metaphosphate, potassium tripolyphosphate, sodium trimetaphosphate, ammonium hypophosphite, ammonium dihydrogen phosphite, manganese phosphate, dizinc hydrogen phosphate, dimanganese hydrogen phosphate, guanidine phosphate, melamine phosphate, urea phosphate, strontium dimetaborate hydrogen phosphate, boric acid, ammonium pentaborate, potassium tetraborate octahydrate, magnesium metaborate octahydrate, ammonium tetraborate tetrahydrate, strontium metaborate, strontium tetraborate, strontium tetraborate tetrahydrate, sodium tetraborate decahydrate, manganese borate, zinc borate, ammonium fluoroborate, ammonium ferrous sulfate, aluminum sulfate, potassium aluminum sulfate, ammonium aluminum sulfate, ammonium sulfate, magnesium hydrogen sulfate, aluminum hydroxide, magnesium hydroxide, iron hydroxide, cobalt hydroxide, bismuth hydroxide, strontium hydroxide, cerium hydroxide, lanthanum hydroxide, molybdenum hydroxide, ammonium molybdate, zinc stannate, magnesium trisilicate, telluric acid, manganese tungstate, manganite, cobaltocene, 5-aminotetrazole, guanidine nitrate, azobisformamide, nylon powder, oxamide, biuret, pentaerythritol, decabromodiphenyl ether, tetrabromo-phthalic anhydride, dibromoneopentyl glycol, potassium citrate, sodium citrate, manganese citrate, magnesium citrate, copper citrate, ammonium citrate, nitroguanidine.

The fire suppressant or compositions thereof can be a liquid, foam, or semi-liquid form, such as, for example, a gel having varying viscosities. In the preferred embodiment, the fire suppressant comprises an aqueous admixture of super absorbent polymer and water having properties which enable the super absorbent polymer and water admixture to be confined to a particular area because of its relatively high viscosity. The properties of the admixture, in particular its viscosity, enable the admixture to remain on vertical, horizontal and curved surfaces formed by the conduit and wires placed therein. Unlike pure water, the admixture does not provide an electrically conductive path. In some embodiments, the present invention adds a predetermined amount of the super absorbent polymer to a predetermined amount of water to obtain an admixture which has properties that enable the admixture to suppress the spread of an electrical fire and extinguish any fire that has attached itself to an individual. In some embodiments, the amounts are from about 1 to 5 pounds of dry super absorbent polymer to about 20 to 40 gallons of water; the amount placed within the receptacles is dependent upon the volume of the receptacles. The preferred size is sufficient to contain approximately 750 gallons in the sealed and pressurized liner. The packaging of the fire suppressant reduces or eliminates evaporation so that the fire suppressant need not be disturbed. If the receptacle needs to be removed quickly, lifting tabs are provided, allowing removal by a forklift. Alternatively, the admixture within the liner can be pumped out through the access port. In the case of a fire and breach, the FIREICE® has the benefit of entrapping the toxic expulsion from the fire to allow ease of disposal. In additional, any residual can be removed by a vacuum once the hydrating water has evaporated.

Currently, firefighters apply water to the electrical conduits which are on fire and which are typically adjacent to other conduits and components, making it difficult to control where the water goes. This contact of water on electrical conduits/components that are not on fire results in substantial unnecessary damage to these conduits/components. In some embodiments, the present invention enables a controlled dispersion of fire suppressant or compositions thereof; for example, a super absorbent polymer water mixture to a specific area for the primary purpose of suppressing the electrical fire at the immediate point of origin. The admixture adheres to the interior of the particular conduit without affecting adjacent conduits/components. Thus, a substantial safety factor is gained because electrical conduits/components are not sprayed and the admixture is not conductive like water.

Besides the risk of electrocution from using water to douse an electrical fire, water will not suppress the noxious and/or toxic gases produced by burning electrical wires, insulation and other components. The preferred fire suppression material, an admixture of potassium based super absorbent polymer marketed under the trademark FIREICE®, is combined with water, providing both physical and chemical properties which enable the admixture to entrap and retain the noxious and/or toxic gasses and prevent the release of these gases into the atmosphere. This is an important advantage that the present invention has over the prior art because it prevents the noxious and/or toxic gases from reaching and affecting the lineman and/or firefighters.

When there are electrical fires in conduits, the firefighters contact the electrical utility to have the electrical power turned off so they can fight the fire. In rare instances, the electrical power is not turned off, which may result in serious injury and/or death of the firefighters when they apply water to the electrical fire. In some embodiments, a fire suppressant or compositions thereof comprises properties such that the fire suppressant or compositions thereof will not readily flow or run from the area into which the fire suppressant or compositions thereof has been applied. Therefore, even in embodiments wherein the fire suppressant or compositions thereof contain water, when the fire suppressant or compositions thereof are applied to a live electrical wire or component, the electricity will not travel back to the firefighter because the fire suppressant or compositions thereof will remain in the immediate area where the fire suppressant or compositions thereof has been applied due to its physical properties and not travel down the conduit. In some embodiments, the fire suppressant or compositions thereof comprise a super absorbent polymer.

The viscosity of the fire suppressant or compositions thereof can be such that the fire suppressant or compositions thereof will not move or migrate past the area into which it was introduced. Therefore, the fire suppressant or compositions thereof can be delivered to a specific area within the conduit and remain in that area and not flow into other areas. Should the material be discharged, clean-up can be performed by vacuuming the material once dried.

Tests were carried out with a super absorbent polymer marketed under the trade name as FIREICE®. The admixture is non-conductive and capable of suppressing harmful air emission released from electrical files.

TEST DESCRIPTION: A total of five field test air sampling collections were undertaken on Jan. 18, 2011, at the High Current Laboratory (HCL) to evaluate the air emissions released from the application of Applicant super absorbent polymer marked under the trademark FIREICE® to artificially faults generated using copper and aluminum cables. The five test scenarios were air sampled for airborne metals and organics. The description of the tests is given in Table 1.

TABLE 1
Test Description

| Test # | Shot # | Test Description | Cable Description |
|---|---|---|---|
| 1 | 119 | New cables with copper conductor artificially | Coned 500 kcmil Cu 600 V |
| | | faulted to create arc with no FIREICE ® added. | EAM/LSNH installed in |
| | | Target fault current: 2 kA. | coned precast concrete |
| | | Fault duration: until fault self-extinguished. | distribution box type B-3.6 |
| 2 | 120 | New cables with copper conductor artificially | Coned 500 kcmil Cu 600 V |
| | | faulted to create arc with FIREICE ® added at | EAM/LSNH installed in |
| | | the on-set of arc. | coned precast concrete |
| | | Target fault current: 2 kA. | distribution box type B-3.6 |
| | | Fault duration: until fault self-extinguished. | |
| 3 | 121 | New cables with copper conductor artificially | Coned 500 kcmil Cu 600 V |
| | | faulted to create arc with FIREICE ® added at | EAM/LSNH installed in |
| | | the on-set of arc - this was a repeat of test #2 | coned precast concrete |
| | | due to poor arc generation and non- | distribution box type B-3.6 |
| | | propagation of arc. | |
| | | Target fault current: 2 kA. | |
| | | Fault duration: until fault self-extinguished. | |
| 4 | 122 | New cables with aluminum conductor | Coned 350 MCM Al 600 V |
| | | artificially faulted to create arc with FIREICE ® | EPR installed in coned |
| | | added at the on-set of arc. | precast concrete distribution |
| | | | box type B-3.6 |
| 5 | 123 | New cables with aluminum conductor | Coned 350 MCM Al 600 V |
| | | artificially faulted to create arc with | EPR installed in coned |
| | | “FIREICE ®” added to concrete box to cover | precast concrete distribution |
| | | faulted cables prior to high current being | box type B-3.6 |
| | | applied to create arc. | |
| | | Target fault current: 2 kA. | |
| | | Fault duration: until fault self-extinguished. | |

In all the tests the cables were installed at the bottom of the concrete box, and the fault between the cables was created using a fuse wire. The approximate dimensions of the interior volume of the concrete box are: 33″×33″×24″. One calorimeter was installed above the concrete box to measure the incident energy generated by the fault.

The sampling equipment consisted of five separate sampling trains, each with a sampling pump drawing air through various air sampling components using a calibrated mass flow controller to maintain constant flow. The sampling time for each train was two minutes during each of the 5 arc test scenarios. For each sampling train, a flow rate was selected based on the type of air sample being collected. The five sampling trains consisted of the following components and the air flow rate utilized:

1. A sampling train consisting of a MCE (mixed cellulose ester) filter in a cartridge filter holder for aerosol collection generated during the arc. The air flow rate through the filter was set to 1 L/min.

2. A sampling train for organic compounds using two CARBOTRAP™ 300 sampling tubes in series (front-back arrangement) was placed with the front sampling tube inlet at the edge of the concrete bunker. The air flow rate for the organics sampling tube train was 0.050 L/min.

3. A sampling train consisting of three impingers in series with 1M nitric acid in the first two impingers and an empty third impinger was used to trap airborne metals. The metals train air flow rate was set to 0.50 L/min.

4. A sampling train identical to the one described in 3, but with 0.5M KOH added to the first two impingers and an empty third impinger was setup, plus an additional CARBOTRAP™ 300 organic compound sampling train as described in 2 was added in series to the outlet of the last impinger. The air sampling flow rate was set to 0.25 L/min for this train.

5. A final sampling train consisting of 3 impingers in series as described in 3, but with KOH added to the first two impingers and an empty third impinger to capture acidic species possibly generated during the FIREICE® tests. The air sampling flow rate was set to 0.25 L/min for this train.

Organic Compound Sampling Results—Carbotrap™300 Tube Analyses

The organic compounds released to air were captured using CARBOTRAP™ 300 tubes after the air sample passed through a KOH impinger train. The sampling flow rate was 0.25 L/min. The total mass of organic compounds collected during each of the five arc fault tests are given in Table 2. The organic compounds identified in the air samples are summarized in Table 3.

TABLE 2
Total Mass of Organic Compounds Collected on CARBOTRAP ™ 300
Sample Tubes and Estimated FIREICE ® Inhibition
Ratio for Organic Compound Release

| | | Total Mass | Minimum |
|---|---|---|---|
| | | of Organics | Removal |
| | | Collected on | Efficiency |
| | | CARBOTRAP ™ | Compared |
| Test Number & Description | | 300 Tubes | to Test1 |
| 1 | Pair of New Neoprene Copper | 615 | — |
| | Cables - No FIREICE ® Applied | | |
| 2 | Pair of New Neoprene Jacketed | 189 | 3.2 |
| | Copper Cables - FIREICE ®- | | |
| | Added at On-Set of Arc | | |
| 3 | Pair of New Neoprene Jacketed | 138 | 4.5 |
| | Copper Cables - FIREICE ®- | | |
| | Added at On-Set of Arc (Repeat) | | |
| 4 | Pair of New Neoprene Jacketed | No Organic | >61.5* |
| | Aluminum Cables - FIREICE ® | Compounds | |
| | Added at On-Set of Arc | Detected | |
| 5 | Pair of New Neoprene Jacketed | No Organic | >61.5* |
| | Aluminum Cables - FIREICE ® | Compounds | |
| | Added Prior to Arc Generation | Detected | |

Note:
*Assumed minimum removal efficiency is assumed to be >61.5 as detection limit for any single organic compound is 10 ng.

TABLE 3
Organic Compounds Identified in High Flow Samples

| | | Organic Compounds Collected | |
|---|---|---|---|
| | | on CARBOTRAP ™ 300 | Total Organic |
| | | Tubes After Passage | Compound Mass |
| Test Number & Description | | Through KOH Impingers | (Front + Back) (ng) |
| 1 | Pair of New Neoprene Copper | ethane-1-chloro-1,1 difluoro* | 48000* |
| | Cables - No FIREICE ® Added | 2-butene, 2-methyl | 18 |
| | | 1,3-butadiene, 2-methyl | 40 |
| | | 1,3 pentadiene | 35 |
| | | 1,4 pentadiene | 14 |
| | | cyclopentane | 23 |
| | | 1-pentene, 2-methyl | 36 |
| | | benzene | 62 |
| | | 1,4-cyclohexadiene | 25 |
| | | 3-hexen-1-ol | 28 |
| | | toluene | 237 |
| | | ethylbenzene | 48 |
| | | styrene** | 2740** |
| | | a-methyl styrene** | 53** |
| 2 | Pair of New Neoprene Jacketed | ethane-1-chloro-1,1-difluoro | 68* |
| | Copper Cables - FIREICE ®- | 1,3-butadiene | 14 |
| | Added at On-Set of Arc | 1-pentene, 2-methyl | 21 |
| | | propane, 2-methyl-1-nitro | 31 |
| | | 3-heptene | 8 |
| | | benzene | 62 |
| | | butane, I-chloro-2-methyl | 25 |
| | | styrene** | 99** |
| | | unknown | 28 |
| 3 | Pair of New Neoprene Jacketed | ethane-1-chloro-1,1-difluoro | 264* |
| | Copper Cables - FIREICE ®- | 1-propene, 2-methyl | 16 |
| | Added at On-Set of Arc (Repeat) | 1,3-butadiene | 40 |
| | | 2-butene, 2-methyl | 12 |
| | | 1-pentene, 2-methyl | 25 |
| | | benzene | 34 |
| | | unknown | 11 |
| 4 | Pair of New Neoprene Jacketed | No organic compounds | 0 |
| | Aluminum Cables - FIREICE ® | detected on both front and back | |
| | Added at On-Set of Arc | CARBOTRAP ™ 300 tubes | |
| 5 | Pair of New Neoprene Jacketed | No organic compounds | 0 |
| | Aluminum Cables - FIREICE ® | identified on both front and back | |
| | Added Prior to Arc Generation | CARBOTRAP ™ 300 | |

Notes:
*The ethane-1-chloro-1,1-difluoro is suspected to be contamination resulting from the partial decomposition of impinger train holder used during testing. The Freon HCFC 142b released during tests 1 to 3 is the trapped blowing agent used to make the closed cell foam. The foam was used to support and secure the impinger trains. Not included in organic compound mass reported.
**The styrene and α-methyl styrene are unintentional contaminants generated from the destruction of the aerosol filter holder used during the first arc fault Test-1. The filter- holder was too close to the arc-fault zone and did not survive Test-1. The styrene values are not included in organic compound mass reported.

Direct Air Sampling—The total mass of organic compounds in the air samples collected directly onto CARBOTRAP™ 300 tubes during each of the five arc fault tests are given in Table 4. The organic compounds captured with the CARBOTRAP™ 300 tubes, and subsequently detected during analysis, are listed in Table 5. The sampling flow rate was 0.05 L/min.

TABLE 4
Total Mass of Organic Compounds on Direct Air
Sample onto Carbotrap ™ 300 Tubes
and FIREICE ® Inhibition Ratio

| | | Total Mass | |
|---|---|---|---|
| | | of Organics | Minimum |
| | | Collected | Removal |
| | | onCARBOTRAP ™ | Efficiency |
| | | 300 Tubes (Front + | Compared |
| Test Number & Description | | Back) (ng) | to Test 1 |
| 1 | Pair of New Neoprene Jacketed | 158 | — |
| | Copper Cables - No FIREICE ® | | |
| 2 | Pair of New Neoprene Jacketed | 65 | 2.4 |
| | Copper Cables - FIREICE ®- | | |
| | Added at On-Set of Arc | | |
| 3 | Pair of New Neoprene Jacketed | 15 | >10 |
| | Copper Cables - FIREICE ®- | | |
| | Added at On-Set of Arc (Repeat) | | |
| 4 | Pair of New Neoprene Jacketed | None | >15.8 |
| | Aluminum Cables - FIREICE ® | Detected | |
| | Added at On-Set of Arc | | |
| 5 | Pair of New Neoprene Jacketed | 10 | 15.8 |
| | Aluminum Cables - FIREICE ® | | |
| | Added Prior to Arc Generation | | |

The total organic compound concentration measured directly with the CARBOTRAP™ 300 tubes associated with the copper cable arc fault in Test-1 is estimated to be 1.6 mg/m3 without the application of FIREICE®. For Test-2 through Test-5, the organic compound concentrations are estimated to be 0.6 mg/m3, 0.15 mg/m3, 0.0 mg/m3, and 0.1 mg/m3, respectively.

The FIREICE® application is effective in reducing organic emissions for both the copper cables and the aluminum cables. The removal efficiencies estimated in Table 2 and Table 4 compare well. The application of FIREICE® reduces organic emissions when applied with the arc fault active. The presence of external contamination confirms the effective organic sampling in the vicinity of the arc fault during the five tests.

TABLE 5
Organic Compounds Identified in Direct Air Samples
Collected on CARBOTRAP ™ 300 Tubes

| | | Organic Compounds Collected | Organic Compound |
|---|---|---|---|
| Test Number &Description | | on CARBOTRAP ™ 300 Tubes | Mass (ng/tube) |
| 1 | Pair of New Neoprene Copper | Ethane-1-chloro-1,1 difluoro* | 53* |
| | Cables - No FIREICE ® Added | 1-pentene, 2-methyl | 15 |
| | | Benzene | 64 |
| | | toluene** | 41 |
| | | Styrene | 70 |
| | | methyl styrene** | 217* |
| | | isobutyl nitrile | 11 |
| | | propane, 2-methyl-1-nitro | 14 |
| | | unknown | 13 |
| 2 | Pair of New Neoprene Jacketed | 1-propene, 2-methyl | 8 |
| | Copper Cables - FIREICE ®- | 1,3 butadiene | 16 |
| | Added at On-Set of Arc | 2-butene, 2-methyl | 8 |
| | | 1-pentene, 2-methyl | 23 |
| | | unknown | 10 |
| 3 | Pair of New Neoprene Jacketed | 1-pentene, 2-methyl | 15 |
| | Copper Cables - FIREICE ®- | | |
| | Added at On-Set of Arc (Repeat) | | |
| 4 | Pair of New Neoprene Jacketed | No organic compounds | 0 |
| | Aluminum Cables - FIREICE ® | detected on both front and back | |
| | Added at On-Set of Arc | CARBOTRAP ™ 300 tubes | |
| 5 | Pair of New Neoprene Jacketed | No organic compounds | 0 |
| | Aluminum Cables - FIREICE ® | identified on both front and back | |
| | Added Prior to Arc Generation | CARBOTRAP ™ 300 tubes | 10 |
| | | Unknown peak (front tube only) | |

Notes:
*The ethane-1-chloro-1,1-difluoro is suspected to be contamination resulting from the partial decomposition of impinger train holder used during testing. The Freon HCFC 142b released during testing is the trapped blowing agent used to make the closed cell foam. The foam was used to support and secure the impinger trains. The Freon was not included in organic compound mass reported.
**The styrene and α-methyl styrene are unintentional contaminants generated from the destruction of the aerosol filter holder used during the first arc fault Test-1. The filter- holder was too close to the arc-fault zone and did not survive Test-1. The styrene values are not included in organic compound mass reported.

TABLE 6
Metals Analysis Results (PPM) Filter
Pack Sampling ~2 m Above Arc Fault

| | Blank | Test 2 | Test 3 | Test 4 | Test 5 |
|---|---|---|---|---|---|
| Metal | (Avg) | (Cu) | (Cu) | (Al) | (Al) |
| Al | <0.5 | 3.15 | 6.81 | 1.48 | <0.5 |
| Ca | 2.15 | 1.80 | 4.96 | 2.52 | 1.93 |
| Cu | <1.5 | 94.8 | 312 | 1.98 | <1.5 |
| Fe | <0.25 | <0.25 | 2.85 | <0.25 | <0.25 |
| K | 67 | 68 | 39 | 28 | 23 |
| Mg | 0.19 | 8.4 | 18.9 | 0.25 | <0.1 |
| Na | <2.5 | <2.5 | 5.8 | <2.5 | <2.5 |
| P | <1 | <1 | 1.2 | <1 | <1 |
| S | <1 | <1 | 3.7 | <1 | <1 |
| Si | <1 | 4.3 | 20.5 | <1 | <1 |
| Ag | <0.005 | <0.005 | 0.007 | <0.005 | <0.005 |
| As | <0.05 | <0.05 | <0.05 | <0.05 | <0.05 |
| B | <0.05 | <0.05 | <0.05 | <0.05 | <0.05 |
| Ba | 0.007 | 0.012 | 0.022 | 0.008 | 0.006 |
| Bi | <0.005 | <0.005 | <0.005 | <0.005 | <0.005 |
| Be | <0.005 | <0.005 | <0.005 | <0.005 | <0.005 |
| Cd | <0.005 | <0.005 | <0.005 | <0.005 | <0.005 |
| Co | <0.005 | <0.005 | <0.005 | <0.005 | <0.005 |
| Cr | <0.005 | <0.005 | <0.005 | <0.005 | <0.005 |
| Cs | <0.005 | <0.005 | <0.005 | <0.005 | <0.005 |
| Li | <0.005 | <0.005 | 0.013 | <0.005 | <0.005 |
| Mn | 0.005 | 0.006 | 0.053 | 0.007 | 0.006 |
| Mo | <0.005 | <0.005 | <0.005 | <0.005 | <0.005 |
| Ni | 0.010 | 0.013 | 0.024 | 0.016 | 0.011 |
| Pb | <0.005 | 1.93 | 4.79 | 0.063 | 0.015 |
| Sb | 0.003 | 2.17 | 5.19 | 0.072 | 0.017 |
| Se | <0.05 | <0.05 | <0.05 | <0.05 | <0.05 |
| Sn | 0.029 | 0.036 | 0.028 | 0.006 | 0.005 |
| Sr | 0.007 | 0.006 | 0.028 | 0.009 | 0.006 |
| Th | <0.005 | <0.005 | <0.005 | <0.005 | <0.005 |
| Ti | 0.151 | 0.122 | 0.309 | 0.007 | 0.007 |
| Th | <0.005 | <0.005 | <0.005 | <0.005 | <0.005 |
| W | <0.005 | <0.005 | <0:005 | <0.005 | <0.005 |
| Zr | <0.005 | <0.005 | <0.005 | <0.005 | <0.005 |
| V | <0.05 | <0.05 | <0.05 | <0.05 | <0.05 |
| Zn | 0.037 | 1.22 | 3.02 | 0.054 | 0.042 |
| Hg | <0.005 | <0.005 | <0.005 | <0.005 | <0.005 |
| U | <0.005 | <0.005 | <0.005 | <0.005 | <0.005 |

TABLE 7
Metals Analysis Results (PPM) from Acid Impinger Sampler Train

| | | Test 1 | Test 2 | Test 3 | Test 4 | Test 5 |
|---|---|---|---|---|---|---|
| Metal | MDL | (Cu) | (Cu) | (Cu) | (Al) | (Al) |
| Al | <0.01 | 0.145 | 0.272 | 0.330 | 0.328 | 0.640 |
| Ca | <0.01 | 0.485 | 1.30 | 0.388 | 0.523 | 0.094 |
| Cu | <0.01 | 0.22 | 0.918 | 0.816 | 0.66 | 0.062 |
| Fe | <0.005 | 0.02 | 0.056 | 0.023 | 0.028 | 0.025 |
| K | <0.01 | 1.24 | 0.896 | 0.644 | 77.8 | 13000 |
| Mg | <0.002 | 0.042 | 0.134 | 0.056 | 0.318 | 0.012 |
| Na | <0.05 | 0.951 | 0.727 | 1.78 | 0.905 | 10.5 |
| P | <0.02 | <0.02 | 0.049 | <0.02 | <0.02 | <0.02 |
| S | <0.05 | 0.043 | 0.070 | 0.099 | 0.043 | 0.504 |
| Si | <0.1 | 0.303 | 0.48 | 1.10 | 0.49 | 21.4 |
| Ag | <0.0001 | 0.004 | 0.005 | 0.004 | 0.005 | 0.002 |
| As | <0.001 | <0.001 | <0.001 | <0.001 | <0.001 | <0.001 |
| B | <0.025 | 0.853 | 0.638 | 1.61 | 0.922 | 2.88 |
| Ba | <0.0001 | 0.006 | 0.008 | 0.007 | 0.006 | 0.002 |
| Bi | <0.001 | <0.001 | <0.001 | <0.001 | <0.001 | <0.001 |
| Be | <0.001 | <0.001 | <0.001 | <0.001 | <0.001 | <0.001 |
| Cd | <0.0001 | <0.0001 | <0.0001 | <0.0001 | 0.0002 | <0.0001 |
| Co | <0.0001 | 0.0001 | 0.0004 | <0.0001 | 0.0002 | 0.0001 |
| Cr | <0.0001 | 0.0007 | 0.0009 | 0.0006 | 0.0006 | 0.019 |
| Cs | <0.0001 | <0.0001 | <0.0001 | <0.0001 | 0.002 | 0.819 |
| Li | <0.001 | <0.001 | <0.001 | <0.001 | <0.001 | 0.004 |
| Mn | <0.0001 | 0.001 | 0.002 | 0.0006 | 0.0010 | 0.015 |
| Mo | <0.0001 | 0.0002 | 0.0002 | 0.0003 | 0.0002 | 0.0020 |
| Ni | <0.0001 | 0.002 | 0.001 | 0.002 | 0.002 | 0.001 |
| Pb | <0.0001 | 0.003 | 0.003 | 0.008 | 0.009 | 0.008 |
| Sb | <0.001 | 0.002 | 0.002 | 0.007 | 0.003 | <0.001 |
| Se | <0.001 | <0.001 | <0.001 | <0.001 | <0.001 | 0.004 |
| Sn | <0.0001 | 0.0004 | 0.0003 | 0.0002 | 0.0005 | 0.0020 |
| Sr | <0.0001 | 0.002 | 0.005 | 0.002 | 0.003 | 0.001 |
| Th | <0.0001 | <0.0001 | <0.0001 | <0.0001 | <0.0001 | <0.0001 |
| Ti | <0.0001 | 0.001 | 0.004 | 0.002 | 0.002 | 0.014 |
| Tl | <0.0001 | <0.0001 | <0.0001 | <0.0001 | <0.0001 | <0.0001 |
| W | <0.0001 | <0.0001 | <0.0001 | <0.0001 | 0.0001 | 0.037 |
| Zr | <0.0001 | 0.0002 | 0.0008 | 0.0007 | 0.0007 | 0.027 |
| V | <0.0001 | <0.0001 | <0.0001 | <0.0001 | <0.0001 | 0.0002 |
| Zn | <0.0001 | 0.01 | 0.009 | 0.01 | 0.021 | 0.003 |
| Hg | <0.0001 | <0.0001 | <0.0001 | <0.0001 | <0.0001 | <0.0001 |
| U | <0.0001 | <0.0001 | <0.0001 | <0.0001 | <0.0001 | <0.0001 |

A 2-liter air sample was taken through a filter pack at about 2 meters above each arc test. Each available exposed filter was analyzed for metals and other elements. The results for 38 element analyses are presented in Table 6.

Some key observations are noted from filter analysis for the Test-2 through Test-5 data available in Table 6: A key result noted is the below detection of aluminum for Test 5 compared to a measurable detection in Test 4. Both tests used new aluminum cables for the arc fault, but in the Test 5 case the fault zone was encapsulated in FIREICE® prior to arc fault generation; whereas for Test 4, the arc fault was initiated into air and then FIREICE® was added to quench the arc fault. The lead (Pb), antimony (Sb), magnesium (Mg), copper (Cu), and calcium (Ca) results add confirmation to the reduction of released metals with the arc fault encapsulated.

The counter ion for FIREICE® is potassium (K). For all four arc fault tests, the filter analyses did not detect potassium above the nominal background concentration of potassium present on the filter prior to exposure. This is evidence that FIREICE® did not undergo detectable degradation during the arc faults where FIREICE® was applied.

Test 2 and Test 3 were essentially duplicate tests using new neoprene jacketed copper cables for the arc fault, with Test 3 having the more sustained arc fault. The procedure for applying FIREICE® was the same for both tests. At the on-set of the arc fault, the addition of FIREICE® was begun and continued until the concrete cell was about ½ full. For the more sustained arc fault (Test 3), the key metals from the vaporized copper cable (as measured with the filter pack) were about 3 to 4 times higher than the metals released in the much shorter arc period of Test 2. Key metals released were aluminum (1.7%), copper (80%), magnesium (4.8%), zinc (0.8%), lead (1.2%), calcium (1.3%) and antimony (1.3%) with remaining components at <1% to only present at trace levels.

The estimated airborne total metals concentration for Test 3 is 0.17 g/m³, and for Test 2 is 0.058 g/m³. Similarly, for the aluminum cables the estimated airborne total metals concentration for Test 4 is 0.003 g/m³, and for Test 5 is 0.001 g/m³.

For comparison, the Ontario Ministry of Labor Time-Weighted Average Exposure Concentration (TWAEC) for a variety of fumes and particulates, ranges from 0.003 to 0.01 g/m³ for 40-hr work week; and for short term exposures, the particulate concentrations range from 0.005 to 0.02 g/m³ for a maximum 15-minute continuous exposure depending on the fume and particulate present.

Observations from the metals train analyses for Tests 1 through 5 are summarized below and are based on the metal/element analysis data present in Table 7.

The high level of potassium in the Test 5 results were from the entrainment of airborne FIREICE® into the first impinger as the arc generated gas that ejected some of the FIREICE® material into the air. This is confirmed by the increase in silica, sodium and sulfur.

For Test 4, a significant level of copper (0.66 ppm) is measured, as copper residue from Tests 1 to 3 is released during the aluminum cable arc fault. However, in Test 5 very little copper is detected (>10× less detected 0.062 ppm) with the FIREICE® encapsulating the arc fault zone. This is also confirmed by the similar reduction in magnesium detected.

The impinger samples collected similar amounts of metals for the copper cable arc fault tests. The metal concentration levels were and are given in Table 7.

The application of FIREICE® to neoprene jacketed copper and aluminum cables is effective in reducing airborne organic compounds, and also airborne metals. Removal efficiencies from 2 times to greater than 15 times can be expected when added to an active arc fault. For a FIREICE® encapsulated arc fault greater than 60 times, removal of metals and arc generated arc products is possible based on the five tests performed. The optimum admixture is a ratio of 100 grams of FIREICE to 2.5 gallons of clean clear water.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for suppressing an electrical fire within an electrical box having a space, said device comprising:
a flexible receptacle constructed and arranged to consume about 90% of an electrical box space;
a liner placed within said receptacle, said liner formed from a flexible airtight material having at least one port for accessing an interior of said liner; and
fire suppressant composition positioned within said liner;
whereby said receptacle and liner are placed within an electrical box and filled with said fire suppressant, wherein a breach of said liner will release said fire suppressant.

2. The device for suppressing an electrical fire according to claim 1 including an air valve mounted to said port for introducing positive pressure in said interior of said liner.

3. The device for suppressing an electrical fire according to claim 2, wherein said positive pressure is less than 15 psi.

4. The device for suppressing an electrical fire according to claim 2 including a pressure sensor electrically coupled to an alarm, said pressure sensor to detect positive pressure in said liner and activate said alarm when no positive pressure is detected.

5. The device for suppressing an electrical fire according to claim 1 including at least one temperature sensor attached to said liner, said temperature sensor electrically coupled to an alarm to detect an increase in temperature in said liner and activate said alarm upon detection of the increased temperature.

6. The device for suppressing an electrical fire according to claim 5 wherein said alarm is activated when the temperature increases to about 350 degrees Fahrenheit.

7. The device for suppressing an electrical fire according to claim 1, wherein said liner is selected from the group comprising rubber, low density polypropylene, polyurethane, polyisoprene, elastomers, polymers, microfibers, nanofibers or combinations thereof.

8. The device for suppressing an electrical fire according to claim 7, wherein said liner has a melting point of about 350 degrees.

9. The device for suppressing an electrical fire according to claim 1 wherein said fire suppressant is a biodegradable super absorbent polymer capable of entrapping toxic fumes.

10. The device for suppressing an electrical fire according to claim 9 wherein said fire suppressant is FIREICE®.

11. The device for suppressing an electrical fire according to claim 1 wherein said receptacle is constructed from polyester and sized to hold about 750 gallons of fluid.

12. The device for suppressing an electrical fire according to claim 1 wherein said fire suppressant is a polymer admixed with water at a ratio that makes the admixture non-conductive.

13. The device for suppressing an electrical fire according to claim 1 including at least one strap having a first end secured to an upper edge of said bag and a second end secured to a lower edge of said bag, a buckle attached to said strap for adjusting the distance between said upper and lower edge.
